(19) United States
(12) Patent Application Publication
(10) Pub. No.: US 2020/0104721 A1
(43) Pub. Date: Apr. 2, 2020

(54) NEURAL NETWORK IMAGE SEARCH

(71) Applicant: SCOPEMEDIA INC., Vancouver (CA)

(72) Inventors: Greg MORI, Burnaby (CA); Fred TUNG, Burnaby (CA); Srikanth MURALIDHARAN, Burnaby (CA)

(21) Appl. No.: 16/586,204

(22) Filed: Sep. 27, 2019

Related U.S. Application Data
(60) Provisional application No. 62/737,389, filed on Sep. 27, 2018.

(51) Int. Cl. G06N 3/08; G06K 9/62; G06T 3/40; G06T 5/00; G06F 16/53

(52) U.S. Cl. CPC G06N 3/084; G06K 9/6215; G06F 16/53; G06T 3/40; G06T 5/009; G06K 9/6256

(57) ABSTRACT

Hashing methods and apparatus for large-scale search learn a similarity-preserving transformation from feature space to a lower-dimensional binary space. The resulting binary codes are more compact to store than feature vectors and can be rapidly searched. The hashing methods may be performed without introducing continuous relaxations. Apparatus as described herein comprises a deep neural network that may be trained in a discrete optimization framework without continuous relaxations. The methods and apparatus can be applied to efficiently search image collections without class labels.

### CROSS-REFERENCE TO RELATED APPLICATION

This application claims the benefit under 35 U.S.C. § 119 of U.S. application No. 62/737,389 filed 27 Sep. 2018 and entitled NEURAL NETWORK IMAGE SEARCH which is hereby incorporated herein by reference for all purposes.

### FIELD

This invention relates to image recognition and image searches. Example embodiments provide methods and apparatus which identify target images that are similar to a source image.

### BACKGROUND

It is becoming increasingly important to provide tools that enable computers to search efficiently for images. Images can include still images in any format such as JPEG or TIFF or GIF images as well as video images and individual video image frames. Digital images typically include data representing values assigned to pixels. Such tools have application in a wide range of fields including:
Working with satellite imagery;
Searching for photographs, videos or other images, especially in large collections;
3D reconstruction;
Semantic scene parsing;
Near-duplicate image discovery;
Machine-based handwriting recognition;
Object recognition;
etc.

In this era of big data, and especially big visual data, efficient indexing and searching of large image collections has become increasingly important. Efficient large-scale image retrieval presents many technical challenges. For instance, image representations are often high-dimensional, making them time-consuming to search and also expensive to store. Large-scale image retrieval poses the research question: how can we represent images in a generic, compact, and rapidly searchable form?

One class of techniques for large-scale image search is binary embedding, or hashing. The idea of hashing is to provide a similarity-preserving transformation that transforms feature vectors of an image to a lower-dimensional binary space (a hash). Storing and searching hashes instead of the original feature vectors can yield significant gains in memory and time efficiency. Binary codes can be rapidly compared using bitwise operations supported in modern hardware, and are often orders of magnitude more compact to store than floating point feature vectors.

Traditional hashing methods optimize for a linear or structured projection to map feature vectors to binary. These methods typically take pre-computed features as input.

Early work on locality-sensitive hashing generated similarity-preserving codes using randomized projections. Locality-sensitive hashing has theoretical asymptotic guarantees and is data-independent. However, in practice very long codes are required for accurate image retrieval. This shortcoming led to the development of data-dependent hashing algorithms that learn transformations from training data. Traditionally, hashing algorithms learn a single linear projection as the transformation from feature space (or possibly kernel space) to binary space. Kernel-based hashing methods can capture non-linear structures but do not scale readily to large datasets as they do not obtain the explicit non-linear mapping.

Unsupervised hashing algorithms optimize for a projection that minimizes an unsupervised loss function, such as reconstruction error or quantization error (distortion). Supervised hashing algorithms take as input semantic class labels as well as the features, and learn a projection that minimizes a label-based loss function. As image representations evolved from relatively low-dimensional expert-crafted features such as Gist to high-dimensional deep learning features, hashing algorithms making use of structured projections have been proposed for more efficient encoding.

Large-scale image retrieval may also be approached via vector quantization, which encodes image descriptors using learned codebooks. Vector quantization can often achieve high accuracy in generic approximate nearest neighbor search. However, in the context of image retrieval, the image descriptors must be pre-computed separately and cannot be learned end-to-end.

Traditional hashing approaches for use in image retrieval involve pre-computing expert-crafted features and then learning mappings which transform the features to binary codes.

Recently, deep learning methods have been introduced that learn non-linear mappings from images to binary codes using neural networks. These methods are trainable end-to-end and often better capture the non-linear manifold structure of images. Deep learning approaches may directly take images as input and produce binary codes as output. Such methods allow the image representation to be jointly optimized with the binary embedding.

The following references provide additional background to the present technology:
[1] A. Andoni and P. Indyk. Near-optimal hashing algorithms for approximate nearest neighbor in high dimensions. In Foundations of Computer Science, 2006.
[2] A. Babenko and V. Lempitsky. Tree quantization for large-scale similarity search and classification. In IEEE Conference Computer Vision and Pattern Recognition, 2015.
[3] X. Chang, T. Xiang, and T. M. Hospedales. L1 graph based sparse model for label de-noising. In British Machine Vision Conference, 2016.
[4] M. S. Charikar. Similarity estimation techniques from rounding algorithms. In ACM Symposium on Theory of Computing, 2002.
[5] J.-M. Frahm, P. Fite-Georgel, D. Gallup, T. Johnson, R. Raguram, C. Wu, Y.-H. Jen, E. Dunn, B. Clipp, S. Lazebnik, and M. Pollefeys. Building Rome on a cloudless day. In European Conference on Computer Vision, 2010.
[6] T. Ge, K. He, and J. Sun. Graph cuts for supervised binary coding. In European Conference on Computer Vision, 2014.
[7] A. Gionis, P. Indyk, and R. Motwani. Similarity search in high dimensions via hashing. In International Conference on Very Large Data Bases, 1999.
[8] Y. Gong, S. Lazebnik, A. Gordo, and F. Perronnin. Iterative quantization: a Procrustean approach to learning binary codes for large-scale image retrieval. IEEE Transactions on Pattern Analysis and Machine Intelligence, 35(12):2916-2929, 2013.
[9] Y. Gong, M. Pawlowski, F. Yang, L. Brandy, L. Bourdev, and Fergus. Web scale photo hash clustering on a single machine. In IEEE Conference on Computer Vision and Pattern Recognition, 2015.
[10] K. He, F. Wen, and J. Sun. K-means hashing: an affinity-preserving quantization method for learning binary compact codes. In IEEE Conference on Computer Vision and Pattern Recognition, 2013.
[11] J.-P. Heo, Y. Lee, J. He, S.-F. Chang, and S.-E. Yoon. Spherical hashing. In IEEE Conference on Computer Vision and Pattern Recognition, 2012.
[12] H. Je\acute{ } gou, M. Douze, and C. Schmid. Product quantization for nearest neighbor search. IEEE Transactions on Pattern Analysis and Machine Intelligence, 33(1):117-128, 2011
[13] K. Jiang, Q. Que, and B. Kulis. Revisiting kernelized locality-sensitive hashing for improved large-scale image retrieval. In IEEE Conference on Computer Vision and Pattern Recognition, 2015.
[14] A. Krizhevsky. Learning multiple layers of features from tiny images. Technical report, 2009.
[15] B. Kulis and T. Darrell. Learning to hash with binary reconstructive embeddings. In Advances in Neural Information Processing Systems, 2009.
[16] B. Kulis and K. Grauman. Kernelized locality-sensitive hashing. IEEE Transactions on Pattern Analysis and Machine Intelligence, 34(6):1092-1104, 2012.
[17] H. Lai, Y. Pan, Y. Liu, and S. Yan. Simultaneous feature learning and hash coding with deep neural networks. In IEEE Conference on Computer Vision and Pattern Recognition, 2015.
[18] Y. LeCun, L. Bottou, Y. Bengio, and P. Haffner. Gradient-based learning applied to document recognition. Proceedings of the IEEE, 86(11):2278-2324, 1998.
[19] G. Levin, D. Newbury, K. McDonald, I. Alvarado, A. Tiwari, and M. Zaheer. Terrapattern: Open-ended, visual query-by-example for satellite imagery using deep learning. http://terrapattern.com, May 2016.
[20] K. Lin, J. Lu, C.-S. Chen, and J. Zhou. Learning compact binary descriptors with unsupervised deep neural networks. In IEEE Conference on Computer Vision and Pattern Recognition, 2016.
[21] V. E. Liong, J. Lu, G. Wang, P. Moulin, and J. Zhou. Deep hashing for compact binary codes learning. In IEEE Conference on Computer Vision and Pattern Recognition, 2015.
[22] H. Liu, R. Wang, S. Shan, and X. Chen. Deep supervised hashing for fast image retrieval. In IEEE Conference on Computer Vision and Pattern Recognition, 2016.
[23] W. Liu, J. Wang, R. Ji, Y.-G. Jiang, and S.-F. Chang. Supervised hashing with kernels. In IEEE Conference on Computer Vision and Pattern Recognition, 2012.
[24] J. Martinez, J. Clement, H. H. Hoos, and J. J. Little. Revisiting additive quantization. In European Conference on Computer Vision, 2016.
[25] K. Matzen and N. Snavely. Scene chronology. In European Conference on Computer Vision, 2014.
[26] I. Misra, C. L. Zitnick, M. Mitchell, and R. Girshick. Seeing through the human reporting bias: visual classifiers from noisy human-centric labels. In IEEE Conference on Computer Vision and Pattern Recognition, 2016.
[27] B. Ozdemir, M. Najibi, and L. S. Davis. Supervised incremental hashing. In British Machine Vision Conference, 2016.
[28] O. Russakovsky, J. Deng, H. Su, J. Krause, S. Satheesh, Ma, Z. Huang, A. Karpathy, A. Khosla, M. Bernstein, A. C. Berg, and L. Fei-Fei. ImageNet Large Scale Visual Recognition Challenge. arXiv:1409.0575, 2014.
[29] F. Shen, W. Liu, S. Zhang, Y. Yang, and H. T. Shen. Learning binary codes for maximum inner product search. In IEEE International Conference on Computer Vision, 2015.
[30] F. Shen, C. Shen, W. Liu, and H. T. Shen. Supervised discrete hashing. In IEEE Conference on Computer Vision and Pattern Recognition, 2015.
[31] K. Simonyan and A. Zisserman. Very deep convolutional networks for large-scale image recognition. In International Conference on Learning Representations, 2015.
[32] A. Torralba, R. Fergus, and W. T. Freeman. 80 million tiny images: a large data set for nonparametric object and scene recognition. IEEE Transactions on Pattern Analysis and Machine Intelligence, 30(11):1958-1970, 2008.
[33] F. Tung and J. J. Little. SSP: Supervised sparse projections for large-scale retrieval in high dimensions. In Asian Conference on Computer Vision, 2016.
[34] F. Tung and J. J. Little. MF3D: Model-free 3D semantic scene parsing. In IEEE International Conference on Robotics and Automation, 2017.
[35] J. Wang, S. Kumar, and S.-F. Chang. Semi-supervised hashing for large scale search. IEEE Transactions on Pattern Analysis and Machine Intelligence, 34(12):2393-2406, 2012.
[36] X.-J. Wang, L. Zhang, and C. Liu. Duplicate discovery on 2 billion internet images. In IEEE Conference on Computer Vision and Pattern Recognition Workshops, 2013.
[37] Y. Weiss, A. Torralba, and R. Fergus. Spectral hashing. In Advances in Neural Information Processing Systems, 2008.
[38] Y. Xia, K. He, P. Kohli, and J. Sun. Sparse projections for high-dimensional binary codes. In IEEE Conference on Computer Vision and Pattern Recognition, 2015.
[39] F. X. Yu, S. Kumar, Y. Gong, and S.-F. Chang. Circulant binary embedding. In International Conference in Machine Learning, 2014.
[40] T. Zhang, C. Du, and J. Wang. Composite quantization for approximate nearest neighbor search. In International Conference on Machine Learning, 2014.
[41] X. Zhang, F. X. Yu, R. Guo, S. Kumar, S. Wang, and S.-F. Chang. Fast orthogonal projection based on Kronecker product. In IEEE International Conference on Computer Vision, 2015.
[42] F. Zhao, Y. Huang, L. Wang, and T. Tan. Deep semantic ranking based hashing for multi-label image retrieval. In IEEE Conference on Computer Vision and Pattern Recognition, 2015.

There remains a need for new efficient methods and apparatus for image indexing and searching.

### SUMMARY

This invention has a number of aspects. These include, without limitation:
Methods for preparing neural networks to identify digital images;
Apparatus for preparing neural networks to identify digital images;
Neural networks configured by the apparatus and/or methods.

One aspect of the invention provides a method for preparing a deep neural network to generate binary codes corresponding to images. The method may comprise obtaining a plurality of training images and a corresponding plurality of similarity values. Each of the similarity values may indicate a degree of similarity of a pair of the training images. The method may also comprise providing the plurality of images directly as input to the deep neural network to yield binary codes corresponding to the images. The method may also comprise generating an objective function based on the binary codes and the similarity values. The method may also comprise using the objective function, training the deep neural network using an iterative discrete optimization without continuous relaxations.

In some embodiments the deep neural network is a convolutional neural network.

In some embodiments the convolutional neural network comprises at least one convolutional layer, pooling layer or fully connected layer.

In some embodiments the convolutional neural network comprises two or more convolutional layers, pooling layers and fully connected layers.

In some embodiments the deep neural network comprises an input layer. The input layer may comprise a plurality of nodes connected to receive the plurality of images. Each of the plurality of nodes may correspond to a different pixel value in one of the plurality of images.

In some embodiments the plurality of nodes is one of a plurality of sets of nodes of the input layer and the nodes of each of the sets of nodes are connected to receive pixels values of the plurality of images.

In some embodiments the pixel values each comprise a plurality of color values and each of the sets of nodes is connected to receive a different color value.

In some embodiments the color values represent values in a color space selected from a group consisting of LUV, HST, CIELAB, CMYK, CIEXYZ, TSL and HSL color spaces.

In some embodiments the color values represent values in an RGB color space.

In some embodiments the sets of nodes comprise: a first set of nodes connected to receive red color values; a second set of nodes connected to receive green color values; and a third set of nodes connected to receive blue color values.

In some embodiments training the deep neural network is unsupervised.

In some embodiments the discrete optimization comprises alternating between: training the deep neural network as a deep neural network regressor on target binary codes; and updating the target binary codes based on memory and an output of the deep neural network regressor.

In some embodiments the deep neural network regressor is configured as a non-linear regressor.

In some embodiments the plurality of similarity values are computed using pre-computed image features.

In some embodiments the pre-computed image features comprise at least one of: Gist; generic ImageNet-pretrained features not specific to a retrieval task or tuned to the retrieval dataset; and raw pixel intensities.

In some embodiments the deep neural network comprises an architecture of at least one of VGG-16, VGG-19, AlexNet, ResNet and Inception.

In some embodiments the method comprises optimizing parameters of the deep neural network [0032] to generate optimized binary codes in an iterative procedure which comprises alternating between a first procedure and a second procedure wherein the first procedure trains the deep neural network regressor on target binary codes B and the second procedure updates the target binary codes B.

In some embodiments the deep neural network is applied as a non-linear regressor that maps directly from images to the binary codes.

In some embodiments training the deep neural network comprises performing an optimization using an optimization objective function that attempts to maximize a correlation between S and inner products of the k-bit binary codes wherein: A and X denote sets of the training images, h(•) and z(•) are non-linear functions implemented using the deep neural network, H:Ω→{−1, 1}^{k} and Z:Ω→{−1, 1}^{k} denote mappings from an image space Ω to the k-bit binary codes, and S is a similarity matrix having entries Sᵢⱼ which have values that indicate the visual similarity between the ith image in A and the jth image in X.

In some embodiments the optimization objective function is as follows:

max_{h,z} trace(H(A)SZ(X)^{T}).

In some embodiments the optimization objective function is as follows:

min∥H(A)^{T}Z(X)−S∥_{F}². (3A)

In some embodiments the optimization objective function comprises a discrete sign function and sgn(.) and the method comprises, in successive iterations, without relaxing the discrete sign function, alternating between holding z fixed and solving for h, and holding h fixed and solving for z.

In some embodiments, for holding z fixed and solving for h the optimization objective function is given by:

$${max}_{h} trace ( sgn ( h ( A ) ) {( SZ )}^{T}$$

where Z ∈ {−1, 1}^{k×|X|} are fixed binary codes.

Some embodiments comprise separating the non-linear function h(•) from the sign function sgn(.) using an auxiliary binary variable B representing the binary codes.

Some embodiments comprise iteratively alternating between holding h fixed and solving for B, and holding B fixed and solving for h.

In some embodiments, holding B fixed and solving for h comprises training the deep neural network using backpropagation and a loss function that provides a measure of differences between B and h(A).

The methods described herein may comprise mapping query images or stored images using the deep neural network to yield corresponding binary codes for the query images or the stored images and using the corresponding binary codes to assess similarity of the query images or the stored images to other images.

Another aspect of the invention provides a method for retrieving from a database images similar to an input image. The method may comprise providing the input image directly as input to a deep neural network trained to generate an output binary code corresponding to the input image. The method may also comprise searching a plurality of binary codes corresponding to a plurality of stored images using the output binary code. The method may also comprise retrieving images from the plurality of stored images with binary codes similar to the output binary code. Training the deep neural network may comprise obtaining a plurality of training images and a corresponding plurality of similarity values. Each of the similarity values may indicate a degree of similarity of a pair of the training images. Training the deep neural network may also comprise providing the plurality of images directly as input to the deep neural network to yield binary codes corresponding to the images. Training the deep neural network may also comprise generating an objective function based on the binary codes and the similarity values. Training the deep neural network may also comprise using the objective function, training the deep neural network using an iterative discrete optimization without continuous relaxations.

In some embodiments the method for retrieving from the database images similar to the input image comprises updating the plurality of binary codes corresponding to the plurality of stored images based on changes in one or both of the types of and number of images in the plurality of stored images.

In some embodiments providing the input image directly as input to the deep neural network comprises preprocessing the input image into a format receivable by the deep neural network.

In some embodiments preprocessing the input image comprises at least one of: changing a size of the image; changing to a selected bit depth; transforming to a selected color format; and performing image adjustments.

In some embodiments changing the size of the input image comprises at least one of upsampling, downsampling, decimating, interpolating, padding and cropping of the input image.

In some embodiments performing image adjustments comprises adjusting by tone mapping at least one of contrast, maximum brightness and black level.

Further aspects and example embodiments are illustrated in the accompanying drawings and/or described in the following description.

### BRIEF DESCRIPTION OF THE DRAWINGS

The accompanying drawings illustrate non-limiting example embodiments of the invention.

FIG. 1 is a data flow diagram illustrating an example deep discrete hashing method and apparatus for learning binary codes for large-scale retrieval that is trainable without class labels.

FIG. 2 is a data flow diagram illustrating an example process for training a deep neural network for learning binary codes within an iterative discrete optimization framework without continuous relaxations.

FIGS. 3A, 3B, and 3C show 16 bit, 32 bit, and 64 bit precision-recall curves respectively for the CIFAR-10 dataset.

FIGS. 4A, 4B, and 4C show 16 bit, 32 bit, and 64 bit precision of top K retrieved neighbors respectively for the CIFAR-10 dataset.

FIG. 5 shows average-case image retrieval results on the CIFAR-10 dataset for, from left to right: query image; top retrieved images using 4096-dimensional VGG-16 feature neighbors; top retrieved images using 64 bit DeepBit codes; top retrieved images using 64 bit UDDH codes.

FIGS. 6A, 6B, and 6C show 16 bit, 32 bit, and 64 bit precision-recall curves respectively for the MNIST dataset.

FIGS. 7A, 7B, and 7C show 16 bit, 32 bit, and 64 bit precision of top K retrieved neighbors respectively for the MNIST dataset.

FIG. 8 shows average-case image retrieval results on the MNIST dataset. From left to right: query image; top retrieved images using 16 bit AIBC [29] codes; top retrieved images using 16 bit UDDH codes.

FIGS. 9A and 9B are graphs showing the effect of varying m and A respectively on the MNIST dataset.

FIGS. 10 and 11 are flow charts illustrating methods for training a deep learning neural network to generate binary codes corresponding to images according to example embodiments.

### DETAILED DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive sense.

One aspect of the present invention applies a deep learning approach for generating binary codes. In this approach a neural network is trained to generate binary codes directly from images in a discrete optimization framework. This approach takes images directly as input and trains a deep neural network to generate codes by a non-linear mapping. Some embodiments are unsupervised (i.e. they do not require class labels). Such embodiments can be applied to collections in which images are not annotated with class labels. Some embodiments formulate an approximate, iterative solution to the discrete problem without continuous relaxations.

This aspect may be applied in various ways including:
configuring a neural network to generate binary codes for images that can be used to assess similarity of different images;
updating the binary codes for images in a database or other grouping, for example, to take into account changes in the types of or number of images present in the database.

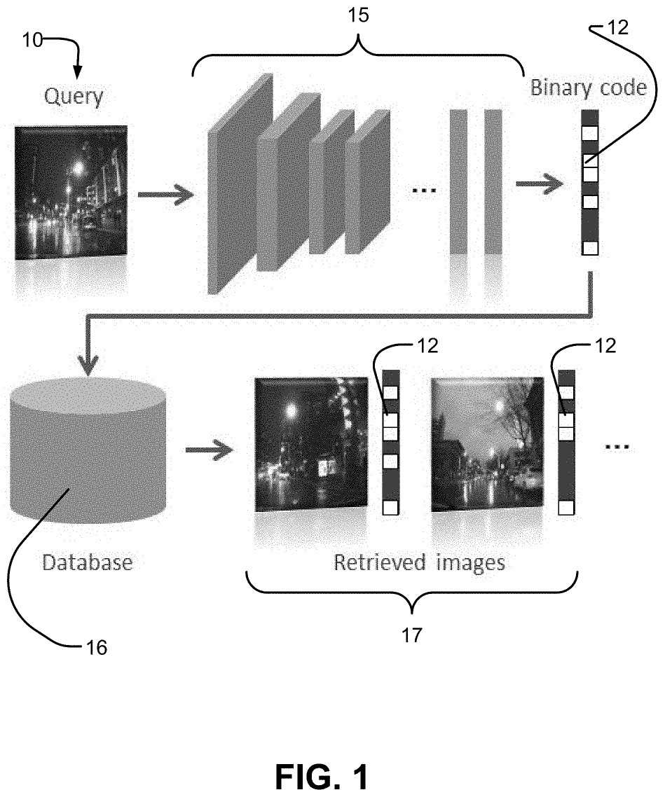

FIG. 1 is a data flow diagram illustrating an example method and apparatus for searching for visually similar images. A novel query image 10 is mapped directly to a binary code 12 by a multi-level neural network 15. Binary code 12 can be used to rapidly search a large collection of images 17 in a database 16 for images that are visually similar to query image 10. Each image 17 has a corresponding binary code 12 produced by neural network 15. Searching for images 17 in database 16 that are visually similar to query image 10 may comprise comparing binary code 12 for query image 10 to binary codes 12 for images 17 using a suitable similarity measure and selecting those images 17 for which the similarity measure indicates greatest similarity. Preferably the method is unsupervised.

Neural network 15 may have any of a wide variety of configurations. In some embodiments, neural network 15 is a convolutional neural network which converts an input (e.g. query image 10) into a fixed length feature vector. Non-limiting example architectures that may be used for neural network 15 include: VGG-16, VGG-19, AlexNet, ResNet and Inception architectures. In some embodiments, neural network 15 comprises at least one convolutional layer, pooling layer or fully connected layer as described in CS231n Convolutional Neural Networks for Visual Recognition, Stanford University (http://cs231n.github.io/convolutional-networks/) which is hereby incorporated herein by reference in its entirety. In some embodiments, neural network 15 comprises one or more of (in some cases one or more of each of): convolutional, pooling and fully connected layers.

The input to neural network 15 comprises query image 10 or an image 17. Query image 10 and/or image 17 may, for example, be represented as an array of data values assigned to pixels—“pixel values”. Different images may have different formats which may differ according to one or more of:
dimensions (e.g. different numbers of rows and/or columns of pixels);
pixel value formats (e.g. different numbers of bits specifying pixel values);
colour representations (e.g. monochrome, RGB format, YUV format etc.).

In some embodiments, neural network 15 comprises M×N nodes connected to receive query image 10 or image 17, where M×N represents the total number of pixels in image 10 or 17. In some embodiments, neural network 15 comprises an input layer comprising plural sets of M×N nodes connected to receive data from image 10 or 17. In such embodiments, each set of M×N nodes receives a different colour value from each pixel value in image 10 or 17. For example, if each pixel value in an image 10 or 17 represents an RGB value (i.e. each pixel value of image 10 or 17 represents a red colour value, a green colour value and a blue colour value), neural network 15 may comprise three sets of M×N nodes where one set is connected to receive R colour values from the pixels of image 10 or 17, a second set is connected to receive G colour values from the pixels of image 10 or 17 and a third set is connected to receive B colour values from the pixels of image 10 or 17. Similarly, colour values in other colour spaces such as LUV, HST, CIELAB, CMYK, CIEXYZ, TSL, HSL, etc. which include plural colour values for each pixel may be input into separate sets of M×N nodes in neural network 15.

An image 10 or 17 may be preprocessed into a standard format for presentation to neural network 15. Such preprocessing may comprise, for example, one or more of:
changing a size of the image (e.g. by one or more of upsampling, downsampling, decimating, interpolating, padding and cropping);
changing to a selected bit depth;
transforming to a selected colour format;
performing image adjustments (e.g. adjusting contrast, maximum brightness, black level, or the like by tone mapping).

In addition to pixel values for images 10 or 17, neural network 15 may also optionally accept as input information automatically derived from the image 10 or 17 such as one or more of an image histogram, other image statistics, or the like.

A problem is to select parameters for neural network 15 that will result in neural network 15 generating binary codes 12 for images 10 and 17 that allow effective identification of images 17 in database 16 that are visually similar to a query image 10. It is desired that a measure of similarity of the binary codes corresponding to two images should have a high correlation to the similarity of the images themselves.

Parameters for neural network 15 include, for example, weights and/or biases of neurons (nodes) in neural network 15. In some embodiments, neural network 15 comprises parameters and hyper-parameters as described in CS231n Convolutional Neural Networks for Visual Recognition. In some embodiments, the parameters (but not hyper-parameters) for neural network 15 are set by an optimization method described elsewhere herein.

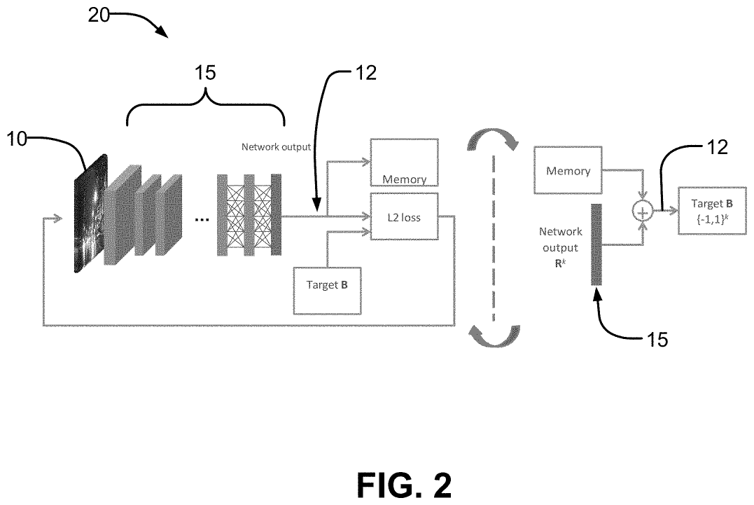

FIG. 2 is a data flow diagram that illustrates an example method 20 for optimizing the parameters of neural network 15 to generate optimized binary codes 12. FIG. 2 illustrates a discrete optimization performed by alternating two procedures. In the first procedure illustrated on the left side of FIG. 2, a deep neural network regressor is trained on target binary codes B. In a second procedure illustrated on the right side of FIG. 2, the target codes are updated based on memory and the network output.

Method 20 applies deep neural network 15 as a non-linear regressor. Method 20 iteratively optimizes discrete codes 12 and the parameters of network 15. Method 20 learns a non-linear, deep neural network mapping directly from images to binary codes. This enables joint optimization of feature representations and binary codes.

Method 20 may operate as follows. Let A and X denote sets of training images. Let H:Ω→{−1, 1}^{k} and Z:Ω→{−1, 1}^{k} denote mappings (hash functions) from RGB image space Ω to k-bit binary codes. Hash functions H and Z may be defined, for example as:

H(I)=sgn(h(I)) (1)

Z(I)=sgn(z(I)) (2)

for an image I ∈ Ω, where sgn(•) is the sign function, and h(•) and z(•) are non-linear functions implemented using deep neural networks.

An example optimization objective is as follows:

max_{h,z} trace(H(A)SZ(X)^{T}) (3)

where H(A) ∈ {−1, 1}^{k×|A|} are the binary codes of training images A generated using the neural network h; Z(X) ∈ {−1, 1}^{k×|X|} are the binary codes of training images X generated using the neural network z; and S is a similarity matrix.

The entry Sᵢⱼ of matrix S defines the visual similarity between the ith image in A and the jth image in X. Intuitively, the discrete optimization problem attempts to maximize the correlation between S and the inner products of the generated binary codes. If two images are similar according to S, then their binary codes should also be similar. Optionally but advantageously, S may be computed without using class labels.

The similarity matrix S may, for example, be computed using the same pre-computed image features that are used as inputs in traditional unsupervised hashing methods. These pre-computed image features may be ‘unsupervised’ in the sense that they are not trained on the target image dataset to be searched: they may be traditional hand-crafted features such as Gist; generic ImageNet-pretrained features not specific to the retrieval task or tuned to the retrieval dataset; or even raw pixel intensities.

An alternative example optimization objective measures the difference between H (A)^{T} Z (X) and similarity matrix S. Such optimization matrix may be represented as follows:

min∥H(A)^{T}Z(X)−S∥_{F}² (3A)

Let A and X denote pre-computed image features of A and X, respectively. S may be obtained, for example, by taking the inner product A^{T}X followed by normalization. This may be done, for example, as described in reference [29] which suggests normalizing S column-wise by setting similarity values in the column to 1 for the m images that are most similar to the image corresponding to the column and setting the remaining similarity values to 0. Preferably the normalization additionally comprises zero-centering S.

Optimization to approach the objective (for example, the objective defined by the function of Eq. 3) may be performed iteratively without relaxing the discrete sign function. In successive iterations the method may alternate between holding z fixed and solving for h, and holding h fixed and solving for z.

Consider the sub-problem of holding z fixed and solving for h. The optimization objective for this sub-problem can be written as:

$${max}_{h} trace ( sgn ( h ( A ) ) {( SZ )}^{T} \qquad ( 4 )$$

where Z ∈ {−1, 1}^{k×|X|} are fixed binary codes. This problem may be addressed by introducing an auxiliary binary variable B representing the binary codes, which separates the non-linear function h(•) from the sign function sgn(.). Use of an auxiliary variable to achieve this separation is described in references [6], [29] and [30].

The optimization objective then becomes

$${max}_{B , h} trace ( {BSZ}^{T} ) - λ {‖ B - h ( A ) ‖}^{2} \\ s . t . B ϵ {\{ - 1 , 1 \}}^{kx \vert A \vert} \qquad ( 5 )$$

This objective may be approached by iteratively alternating between holding h fixed and solving for B, and holding B fixed and solving for h.

### Fix h, Solve for B.

With h (and therefore h(A)) fixed, a closed form solution to Eq. 5 can be derived as follows:

$${max}_{B} trace ( {BSZ}^{T} ) - λ {‖ B - h ( A ) ‖}^{2} = {max}_{B} trace ( {BSZ}^{T} ) - λ trace [ ( B - h ( A ) ) {( B - h ( A ) )}^{T} ] = {max}_{B} trace ( {BSZ}^{T} ) - λ [ trace ( {BB}^{T} ) - 2 trace ( {Bh ( A )}^{T} ) + trace ( h ( A ) {h ( A )}^{T} ) ] = {max}_{B} trace ( {BSZ}^{T} ) + 2 λ trace ( {Bh ( A )}^{T} ) = {max}_{B} trace ( {BSZ}^{T} + 2 λ {Bh ( A )}^{T} ) = {max}_{B} trace ( B ( {SZ}^{T} + 2 λ {h ( A )}^{T} ) ) = {max}_{B} trace ( {\sum }_{i , j} {B}_{ij} {V}_{ij} ) , where V = {ZS}^{T} + 2 λ h ( A ) \qquad ( 6 )$$

In the third step, trace(BB^{T}) can be removed from the maximization because it is a constant MAI. Since B ∈ {−1, 1}^{k×|A|}, this final expression is maximized if Bᵢⱼ=1 whenever Vij≥0 and Bᵢⱼ=−1 whenever Vᵢⱼ<0. Therefore, we have a closed form solution:

B=sgn(ZS^{T}+2λh(A)) (7)

In differing embodiments of the invention described herein, B may be solved for using different computational methods. In some embodiments, B is solved row-wise. In such embodiments solving for B may be performed by solving one row of B, represented by the reference “b”, at a time (e.g. one bit of each k-bit binary code for each image in training set A is solved for at a time) as described in reference [29] which is hereby incorporated herein by reference for all purposes. For example, B may be solved row-wise when performing an optimization to approach the objective defined by Eq. 3A. In some embodiments, B is solved analytically. Solving B analytically may advantageously increase computational speed at which B is solved for and/or decrease computational power required to solve for B. B may be solved analytically when, for example, the size of B is known and Eq. 7 is used to solve for B. In some embodiments, B is approximated using a method of approximation. B may, for example, be approximated in embodiments where B can neither be solved row-wise nor analytically. B may also, for example, be approximated in some embodiments to solve B computationally faster and/or with less computational power being required.

### Fix B, Solve for h.

With B fixed, the problem becomes one of regression, with B being the regression targets. Since h is a non-linear, deep network regressor, h may be trained using a suitable loss function using backpropagation. A suitable loss function may be any function measuring differences between B and h(A). A least squares (L2) loss is a non-limiting example of a suitable loss function. Another non-limiting example of a suitable loss function comprises a L_p norm function and its corresponding monotone increasing function as known in the art. The network h learns a non-linear transformation to regress the target codes B for input images A.

The sub-problem of holding h fixed and solving for z is formulated analogously. Similar to Eq. 4, the optimization objective is

$$= {max}_{B} xtrace ( HS {sgn ( z ( X ) )}^{T} ) \qquad ( 8 )$$

and an analogous alternating scheme may be applied as described above.

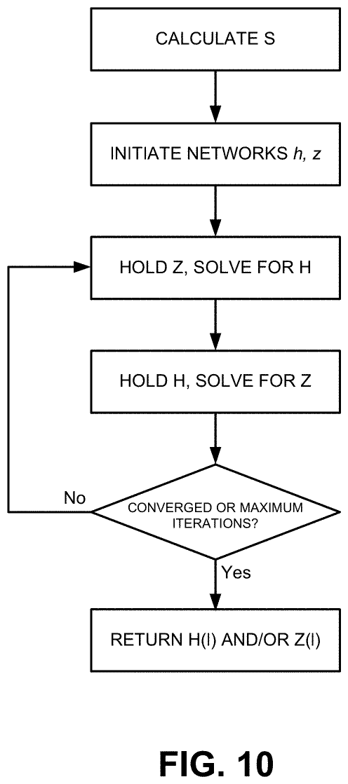

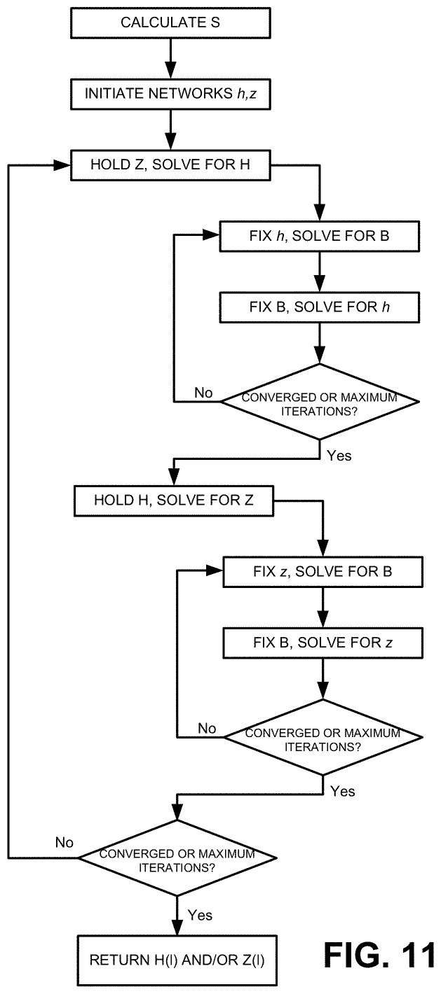

The complete training procedure is summarized in the following example Algorithm 1 and is also illustrated in the flow charts of FIGS. 10 and 11.

Algorithm 1 Training Unsupervised Deep Discrete Hashing

Require: Sets of RGB images A, X; Similarity matrix S; λ;
network hyperparameters for h, z
// Objective: max_{h,z} trace(H(A) S Z(X)^{T})
repeat
/*
Hold Z, solve for H:
max_{B,h} trace(BSZ^{T}) − λ||B − h(A)||²
s.t. B ϵ {−1, 1}^{k×|A|}
*/
repeat
Fix h, solve for B: B = sgn(ZS^{T} + 2λh(A))
Fix B, solve for h: Train h by backpropagation to regress B
until converged or maximum iterations
/*
Hold H, solve for Z:
max_{B, z} trace (HSB^{T}) − λ||B − z (X)||²
s.t. B ϵ {−1, 1}^{k×|X|}
*/
repeat
Fix z, solve for B: B = sgn(HS + 2λz(X))
Fix B, solve for z: Train z by backpropagation to regress B
until converged or maximum iterations
return z// Z(I) = sgn(z(I))

After the parameters of h have been set by optimization as described above, query images 10 and/or stored images 17 may be mapped to yield the corresponding binary codes by Eq. 2. These binary codes may then be compared to determine how similar any of images 17 are to a given query image 10.

### Experiments

The inventors have completed experiments using apparatus and methods as described above on the widely used CIFAR-10 and MNIST datasets which are described respectively in references [14] and [18].

CIFAR-10 is a 60,000 image subset of the Tiny Images database which is described in reference [32]. CIFAR-10 contains 32×32 pixel RGB images. The 60,000 images span 10 semantic classes. The images were split into two groups to provide a database containing 50,000 images and 10,000 disjoint query images.

The MNIST dataset contains 70,000 grayscale images of handwritten digits. Each image is 28×28 pixels. The images were split into two groups to provide 60,000 database images and 10,000 query images.

TABLE 1
Comparison of test results

| | mAP | | | Precision@500 | | |
|---|---|---|---|---|---|---|
| | 16 bits | 32 bits | 64 bits | 16 bits | 32 bits | 64 bits |
| LSH [ [symbol] ] | 23.68 | 28.20 | 33.84 | 22.65 | 26.83 | 32.23 |
| PCAH [ [symbol] ] | 29.92 | 29.11 | 28.22 | 28.43 | 27.12 | 25.73 |
| PCA-ITQ [ [symbol] ] | 36.32 | 39.59 | 42.40 | 35.22 | 38.22 | 40.83 |
| AIBC [ [symbol] ] | 42.75 | 46.44 | 48.30 | 41.90 | 45.44 | 47.25 |
| DeepBit [ [symbol] ] | 20.49 | 25.45 | 29.50 | 19.47 | 24.20 | 27.94 |
| UDDH | 43.18 | 47.45 | 49.43 | 42.24 | 46.29 | 48.08 |

[symbol]

indicates data missing or illegible when filed

Table 1 provides mean average precision (mAP) and precision@500 results on the CIFAR-10 dataset for the prototype implementation of the present method (UDDH) and for a selection of existing unsupervised hashing methods. The existing methods included the deep learning method DeepBit described in reference [20] and traditional LSH, PCAH, PCA-ITQ, and AIBC hashing methods. For the traditional methods (LSH, PCAH, PCA-ITQ, and AIBC) ImageNet-pretrained VGG-16 features were used. However, traditional methods cannot learn image features and binary codes end-to-end.

### Methodology

Retrieval performance was evaluated using mean average precision (mAP) and precision of the top 500 retrieved neighbors (precision@500) for 16 bit, 32 bit, and 64 bit codes. True neighbors are determined by the ground truth class labels in CIFAR-10 and MNIST. Note that class labels are used only in the computation of the evaluation measures, and not during model training because all methods are unsupervised. Precision-recall curves and precision at the top K neighbors (precision@K) were also plotted.

### Implementation Details

Defining separate sets of training images A, X and hash functions H, Z makes the method described above compatible with asymmetric hashing schemes, in which the database and query are encoded using different hash functions. For simplicity X=A in the experiments (H and Z are still optimized as described in Algorithm 1). The entire database (minus the query images which are disjoint) was used for training all methods.

The neural networks were trained using the Caffe™ deep learning framework developed by Berkely AI Research using standard back-propagation and stochastic gradient descent. For CIFAR-10, the base VGG-16 network was initialized with ImageNet-pretrained weights and a fixed learning rate was set to 0.0001. In each inner iteration of Algorithm 1 (i.e. Fix B, solve for h or z) the network was trained for one epoch.

For MNIST, the neural network was trained from scratch with a fixed learning rate of 0.001. In each iteration the network was trained for three epochs.

The value m for computing similarity matrix S was set to 300 and the value A was set to 100 for both datasets.

### CIFAR 10 Results

Table 1 shows results on the CIFAR-10 dataset with a comparison to other unsupervised hashing methods. For the traditional unsupervised hashing methods (LSH [4], PCAH [35], PCA-ITQ [8], and AIBC [29]), ImageNet-pretrained VGG-16 features were used. The state-of-the-art deep baseline DeepBit [20] was also tested. The mean average precision (mAP) was computed over the first 1000 retrieved neighbors.

Table 1 shows that traditional hashing approaches achieve very high retrieval accuracy given ImageNet-pretrained VGG-16 features. These hashing approaches even outperformed DeepBit, which uses a network architecture based on VGG-16. However, feature extraction must be performed separately and cannot be learned end-to-end as in the deep hashing approaches.

All numbers in Table 1 are computed using DeepBit's public evaluation code, which reproduces the DeepBit results reported above. The methods as described herein (UDDH) demonstrated significant improvements in accuracy, over 20% mAP, with respect to the DeepBit base-line at all code lengths.

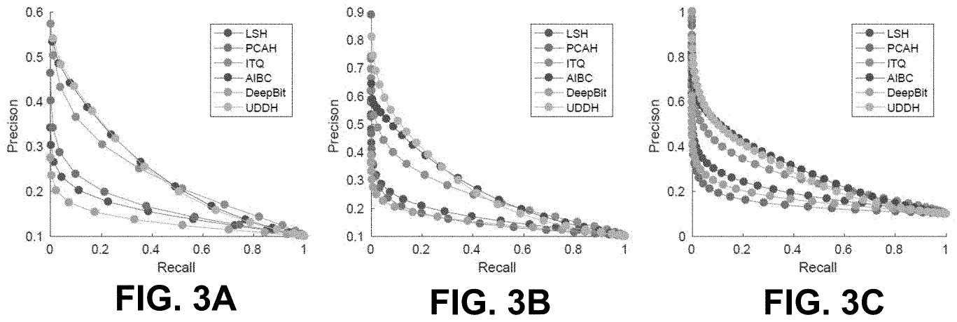

FIGS. 3A to 3C show precision-recall curves for 16 bit, 32 bit, and 64 bit codes respectively. UDDH and the traditional discrete hashing method AIBC obtain the best overall performance, especially in the high-precision range, reflecting the improvement possible from learning binary codes using discrete optimization without continuous relaxations.

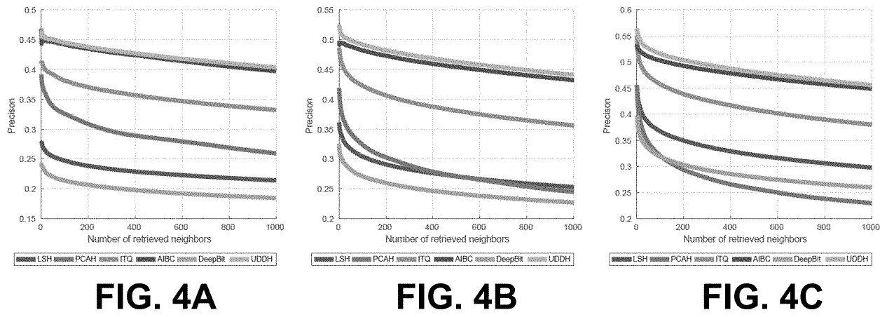

FIGS. 4A to 4C show how the precision varies with the number of retrieved binary-space neighbors for 16 bit, 32 bit, and 64 bit codes respectively. Images retrieved using UDDH are the most likely to be true neighbors of the query. The precision difference between UDDH and AIBC is small, however AIBC cannot learn image features end-to-end and is provided strong ImageNet-pretrained VGG-16 features as input.

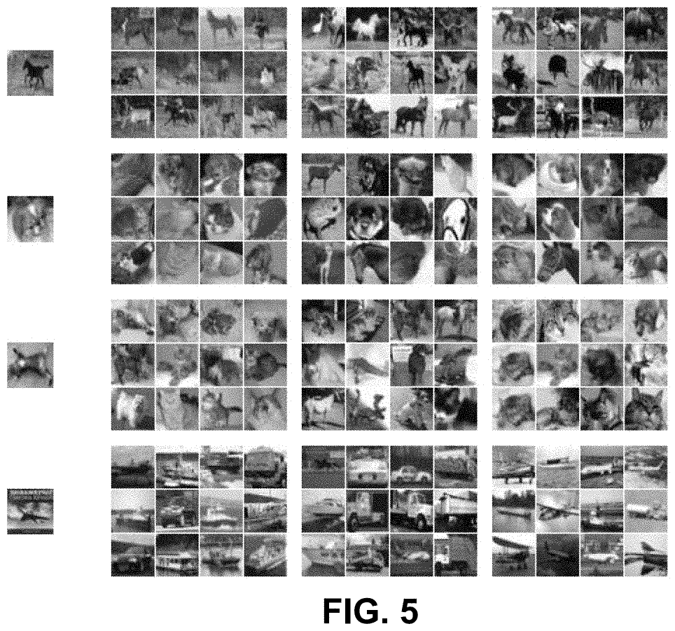

FIG. 5 shows examples of average-case retrieval results at 64 bits. Compared with DeepBit codes and VGG-16 feature neighbors, the UDDH codes are more effective at capturing semantic and visual neighbors. Notice that the images retrieved by the UDDH codes tend to be similar in appearance even when they do not belong to the same class. Replacing 4096-dimensional VGG-16 features with 64 bit binary codes enables a reduction in memory requirements of three orders of magnitude.

### MNIST Results

For MNIST the 28×28 image intensities were used as the unsupervised image features. LeNet which is described in reference [18] was used as the base network which was trained from scratch without class labels as described herein.

Table 2 shows results obtained from the UDDH method and for comparison also shows results obtained using several existing unsupervised hashing methods. The results summarized in table 2 include mean average precision (mAP) and precision@500 results on the MNIST dataset. Table 2 compares the prototype version of UDDH to unsupervised hashing baselines. The results for LSH, SphH, SpeH, PCAH, KMH, PCA-ITQ, and Deep Hashing are quoted from reference [21]. For a fair comparison with the results described in reference [21] and the baselines quoted from reference [21], the standard mean average precision was computed as the area under the precision-recall curve.

UDDH obtains state-of-the-art unsupervised hashing results on this dataset, improving upon the results of Deep Hashing by 23% mAP at 16 bits and 64 bits, and by 24% mAP at 32 bits. These results again demonstrate the benefit of solving for codes using discrete optimization without continuous relaxations as described herein. The substantial improvement compared with the traditional discrete method AIBC shows the benefit of jointly optimizing for the image representation and discrete codes end-to-end using deep learning.

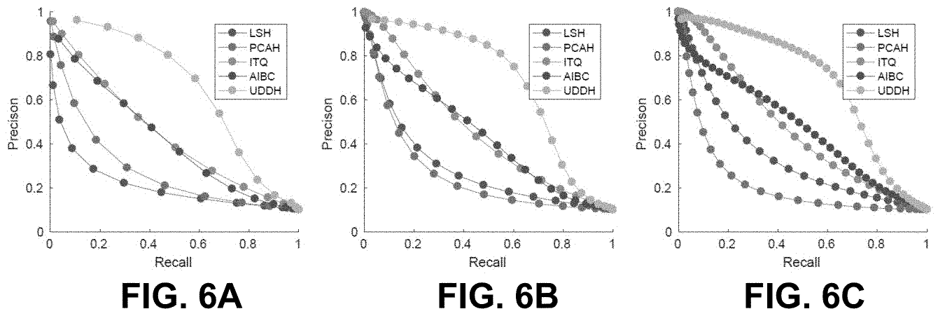

FIGS. 6A to 6C show precision-recall curves for 16 bit, 32 bit, and 64 bit codes respectively. UDDH obtains the best precision-recall tradeoff. The wider gap between the UDDH and AIBC curves compared with CIFAR-10 reflects the fact that for MNIST each of the techniques was trained starting with raw image intensities instead of pre-trained deep features.

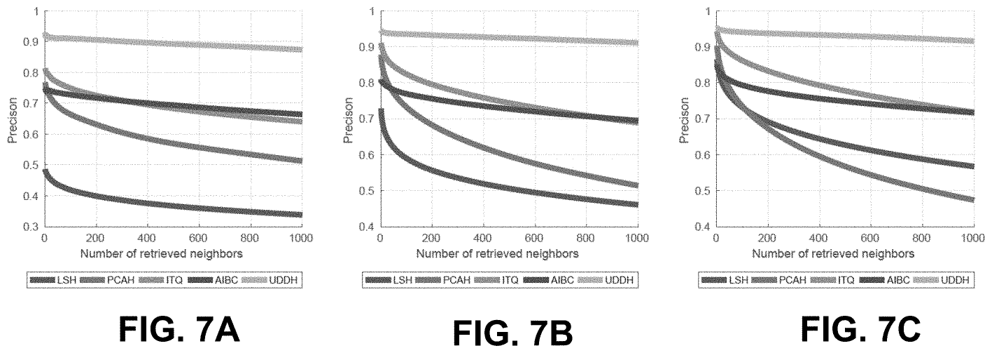

FIGS. 7A to 7C show the precision of the top retrieved binary-space neighbors for 16 bit, 32 bit, and 64 bit codes respectively. While the precision of most methods drops quickly with the number of retrieved images, UDDH continues to return relevant images.

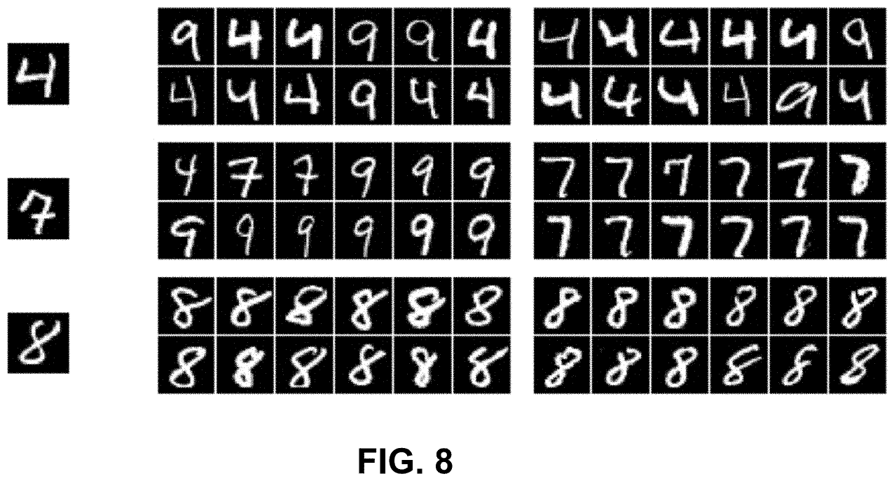

FIG. 8 illustrates some average-case retrieval results at 16 bits. Similar to CIFAR-10, the UDDH method was shown to be effective at capturing both semantic and visual similarities. For example, at 16 bits UDDH achieves a precision@1 of 93%, and in the third example of FIG. 8, the images retrieved using UDDH are closer in appearance than the images retrieved using AIBC.

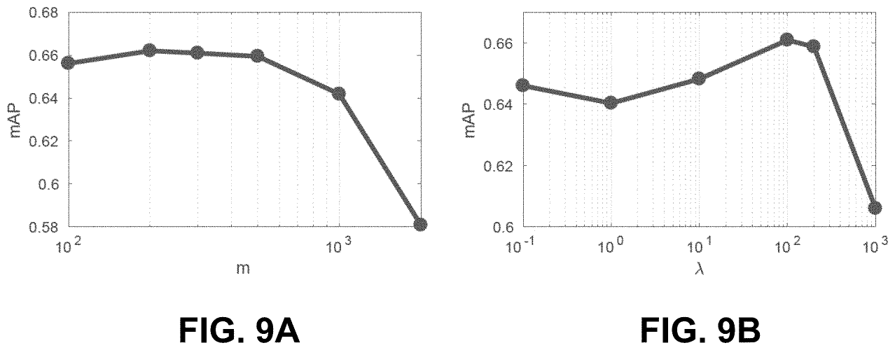

FIGS. 9A and 9B show that the UDDH approach is robust to the choice of m and A respectively.

UDDH leverages a deep neural network as a non-linear regressor in a framework for learning compact binary codes, in which discrete optimization is employed instead of the conventional continuous relaxations. UDDH can provide state-of-the-art unsupervised hashing results on CIFAR-10, including improving on the unsupervised deep hashing results of DeepBit by over 20% mAP. UDDH can provide state-of-the-art unsupervised hashing results on MNIST, improving on the results of Deep Hashing by over 20% mAP.

TABLE 2
Results for MNIST

| | mAP | | | Precision@500 | | |
|---|---|---|---|---|---|---|
| | 16 bits | 32 bits | 64 bits | 16 bits | 32 bits | 64 bits |
| LSH [ [symbol] ] | 20.88 | 25.83 | 31.71 | 37.77 | 50.16 | 61.73 |
| SphH [ [symbol] ] | 25.81 | 30.77 | 34.75 | 49.48 | 61.27 | 69.85 |
| SpeH [ [symbol] ] | 26.64 | 25.72 | 24.10 | 56.29 | 61.29 | 61.98 |
| PCAH [ [symbol] ] | 27.33 | 24.85 | 21.47 | 56.56 | 59.99 | 57.97 |
| KMH [ [symbol] ] | 32.12 | 33.29 | 35.78 | 60.43 | 67.19 | 72.65 |
| PCA-ITQ [ [symbol] ] | 41.18 | 43.82 | 45.37 | 66.39 | 74.04 | 77.42 |
| AIBC [ [symbol] ] | 43.68 | 46.23 | 50.68 | 69.39 | 72.71 | 74.80 |
| Deep | 43.14 | 44.97 | 46.74 | 67.89 | 74.72 | 78.63 |
| Hashing [ [symbol] ] | | | | | | |
| UDDH | 66.09 | 69.44 | 69.93 | 89.24 | 92.45 | 93.06 |

[symbol]

indicates data missing or illegible when filed

### Interpretation of Terms

Unless the context clearly requires otherwise, throughout the description and the
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms.

Words that indicate directions such as “vertical”, “transverse”, “horizontal”, “upward”, “downward”, “forward”, “backward”, “inward”, “outward”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Embodiments of the invention may be implemented using specifically designed hardware, configurable hardware, programmable data processors configured by the provision of software (which may optionally comprise “firmware”) capable of executing on the data processors, special purpose computers or data processors that are specifically programmed, configured, or constructed to perform one or more steps in a method as explained in detail herein and/or combinations of two or more of these. In some embodiments, all steps of a method for configuring a deep neural network as described herein are controlled by hardware configured to coordinate the execution of the method. Examples of specifically designed hardware are: logic circuits, application-specific integrated circuits (“ASICs”), large scale integrated circuits (“LSIs”), very large scale integrated circuits (“VLSIs”), and the like. Examples of configurable hardware are: one or more programmable logic devices such as programmable array logic (“PALs”), programmable logic arrays (“PLAs”), and field programmable gate arrays (“FPGAs”). Examples of programmable data processors are: microprocessors, digital signal processors (“DSPs”), embedded processors, graphics processors, math co-processors, general purpose computers, server computers, cloud computers, mainframe computers, computer workstations, and the like. For example, one or more data processors in a control circuit for a device may implement methods as described herein by executing software instructions in a program memory accessible to the processors.

Processing may be centralized or distributed. Where processing is distributed, information including software and/or data may be kept centrally or distributed. Such information may be exchanged between different functional units by way of a communications network, such as a Local Area Network (LAN), Wide Area Network (WAN), or the Internet, wired or wireless data links, electromagnetic signals, or other data communication channel.

For example, while processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times or in different sequences.

The invention may also be provided in the form of a program product. The program product may comprise any non-transitory medium which carries a set of computer-readable instructions which, when executed by a data processor, cause the data processor to execute a method of the invention (for example, a method for finding images similar to a query image or a method for training a neural network to generate binary codes representing images). Program products according to the invention may be in any of a wide variety of forms. The program product may comprise, for example, non-transitory media such as magnetic data storage media including floppy diskettes, hard disk drives, optical data storage media including CD ROMs, DVDs, electronic data storage media including ROMs, flash RAM, EPROMs, hardwired or preprogrammed chips (e.g., EEPROM semiconductor chips), nanotechnology memory, or the like. The computer-readable signals on the program product may optionally be compressed or encrypted.

In some embodiments, the invention may be implemented in software. For greater clarity, “software” includes any instructions executed on a processor, and may include (but is not limited to) firmware, resident software, microcode, and the like. Both processing hardware and software may be centralized or distributed (or a combination thereof), in whole or in part, as known to those skilled in the art. For example, software and other modules may be accessible via local memory, via a network, via a browser or other application in a distributed computing context, or via other means suitable for the purposes described above.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

Various features are described herein as being present in “some embodiments”. Such features are not mandatory and may not be present in all embodiments. Embodiments of the invention may include zero, any one or any combination of two or more of such features. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible).

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

What is claimed is:

1. A method for preparing a deep neural network to generate binary codes corresponding to images, the method comprising:
obtaining a plurality of training images and a corresponding plurality of similarity values, each of the similarity values indicating a degree of similarity of a pair of the training images;
providing the plurality of images directly as input to the deep neural network to yield binary codes corresponding to the images;
generating an objective function based on the binary codes and the similarity values; and
using the objective function, training the deep neural network using an iterative discrete optimization without continuous relaxations.

2. The method according to claim 1 wherein the deep neural network is a convolutional neural network.

3. The method according to claim 2 wherein the convolutional neural network comprises at least one convolutional layer, pooling layer or fully connected layer.

4. The method according to claim 2 wherein the convolutional neural network comprises two or more convolutional layers, pooling layers and fully connected layers.

5. The method according to claim 1 wherein the deep neural network comprises an input layer, the input layer comprising a plurality of nodes connected to receive the plurality of images wherein each of the plurality of nodes corresponds to a different pixel value in one of the plurality of images.

6. The method according to claim 5 wherein the plurality of nodes is one of a plurality of sets of nodes of the input layer and the nodes of each of the sets of nodes are connected to receive pixel values of the plurality of images.

7. The method according to claim 6 wherein the pixel values each comprise a plurality of color values, each of the plurality of sets of nodes is associated with a different color corresponding to one of the color values and the pixel values that the nodes of each of the sets of nodes is connected to receive are the color values corresponding to the color associated with the set of nodes.

8. The method according to claim 7 wherein the color values represent values in a color space selected from the group consisting of LUV, HST, CIELAB, CMYK, CIEXYZ, TSL and HSL color spaces.

9. The method according to claim 7 wherein the color values represent values in an RGB color space.

10. The method according to claim 9 wherein the sets of nodes comprise:
a first set of nodes connected to receive red color values;
a second set of nodes connected to receive green color values; and
a third set of nodes connected to receive blue color values.

11. The method according to claim 1 wherein training the deep neural network is unsupervised.

12. The method according to claim 1 wherein the discrete optimization comprises alternating between:
training the deep neural network as a deep neural network regressor on target binary codes; and
updating the target binary codes based on memory and an output of the deep neural network regressor.

13. The method according to claim 12 wherein the deep neural network regressor is configured as a non-linear regressor.

14. The method according to claim 1 wherein the plurality of similarity values are computed using pre-computed image features.

15. The method according to claim 14 wherein the pre-computed image features comprise at least one of: Gist, generic ImageNet-pretrained features not specific to a retrieval task or tuned to the retrieval dataset and raw pixel intensities.

16. The method according to claim 1 wherein the deep neural network comprises an architecture of at least one of VGG-16, VGG-19, AlexNet, ResNet and Inception.

17. The method according to claim 1 comprising optimizing parameters of the deep neural network to generate optimized binary codes in an iterative procedure which comprises alternating between a first procedure and a second procedure wherein the first procedure trains the deep neural network regressor on target binary codes B and the second procedure updates the target binary codes B.

18. The method according to claim 17 wherein the deep neural network is applied as a non-linear regressor that maps directly from images to the binary codes.

19. The method according to claim 18 wherein: A and X denote sets of the training images, h(•) and z(•) are non-linear functions implemented using the deep neural network, H:Ω→{−1, 1}^{k} and Z:Ω→{−1, 1}^{k} denote mappings from an image space Ω to k-bit binary codes, and S is a similarity matrix having entries Sᵢⱼ which have values that indicate the visual similarity between the ith image in A and the jth image in X and training the deep neural network comprises performing an optimization using an optimization objective function that attempts to maximize a correlation between S and inner products of the k-bit binary codes.

20. The method according to claim 18 wherein the optimization objective function is as follows:
max_{h,z} trace(H(A)SZ(X)^{T}).

21. The method according to claim 18 wherein the optimization objective function is as follows:
min∥H(A)^{T}Z(X)−S∥_{F}². (4A)

22. The method according to claim 18 wherein the optimization objective function comprises a discrete sign function and sgn(.) and the method comprises, in successive iterations, without relaxing the discrete sign function, alternating between holding z fixed and solving for h, and holding h fixed and solving for z.

23. The method according to claim 22 wherein, for holding z fixed and solving for h the optimization objective function is given by:
$${max}_{h} trace ( sgn ( h ( A ) ) {( SZ )}^{T}$$
where Z ∈ {−1, 1}^{k×|Z|} are fixed binary codes.

24. The method according to claim 23 comprising separating the non-linear function h(•) from the sign function sgn(.) using an auxiliary binary variable B representing the binary codes.

25. The method according to claim 24 comprising iteratively alternating between holding h fixed and solving for B, and holding B fixed and solving for h.

26. The method according to claim 25 wherein holding B fixed and solving for h comprises training the deep neural network using backpropagation and a loss function that provides a measure of differences between B and h(A).

27. The method according to claim 1 comprising mapping query images or stored images using the deep neural network to yield corresponding binary codes for the query images or the stored images and using the corresponding binary codes to assess similarity of the query images or the stored images to other images.

28. A method for retrieving from a database images similar to an input image, the method comprising:
providing the input image directly as input to a deep neural network trained to generate an output binary code corresponding to the input image;
searching a plurality of binary codes corresponding to a plurality of stored images using the output binary code; and
retrieving images from the plurality of stored images with binary codes similar to the output binary code;
wherein training the deep neural network comprises:
obtaining a plurality of training images and a corresponding plurality of similarity values, each of the similarity values indicating a degree of similarity of a pair of the training images;
providing the plurality of images directly as input to the deep neural network to yield binary codes corresponding to the images;
generating an objective function based on the binary codes and the similarity values; and
using the objective function, training the deep neural network using an iterative discrete optimization without continuous relaxations.

29. The method according to claim 28 comprising updating the plurality of binary codes corresponding to the plurality of stored images based on changes in one or both of the types of and number of images in the plurality of stored images.

30. The method according to claim 28 wherein providing the input image directly as input to the deep neural network comprises preprocessing the input image into a format receivable by the deep neural network.

31. The method according to claim 30 wherein preprocessing the input image comprises at least one of:
changing a size of the image;
changing to a selected bit depth;
transforming to a selected color format; and
performing image adjustments.

32. The method according to claim 31 wherein changing the size of the input image comprises at least one of upsampling, downsampling, decimating, interpolating, padding and cropping of the input image.

33. The method according to claim 21 wherein performing image adjustments comprises adjusting by tone mapping at least one of contrast, maximum brightness and black level.
